(19) United States
(12) Patent Application Publication
(10) Pub. No.: US 2008/0005345 A1
(43) Pub. Date: Jan. 3, 2008

(54) Gateway with automatic bridging

(75) Inventors: David A. Roberts, Redmond, WA (US); David G. Thaler, Redmond, WA (US); Glenn R. Ward, Seattle, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/479,840

(22) Filed: Jun. 30, 2006

(51) Int. Cl. G06F 15/16

(52) U.S. Cl. 709/230

(57) ABSTRACT

A gateway device that interfaces an upstream network to one or more downstream networks and provides network address translation may disable network address translation when it is determined that network address translation is already being performed by a device upstream. The gateway device may analyze an address assigned to the upstream network port to determine if it is the range of IP addresses associated with network address translation, typically, 192.168.x.x. Alternately, the gateway device may disable network address translation responsive to a signal from either the device upstream or from an external system manager. DHCP may also be enabled or disabled in conjunction with network address translation.

### BACKGROUND

There are devices that couple data networks to each other. Depending on the range of functions and the nature of the networks, they may have different names. For example, there are simple bridges that connect two or more networks. There are also routers that both connect networks and have additional capability to filter packets, route packets, and perform address translations between networks. The bridges or routers may have firewall capabilities of varying capabilities. Generically, such devices may be called gateway devices. When coupled to the Internet, they may be referred to more specifically as Internet Gateway Devices or IGDs.

Consumer gateway devices, and some commercial gateway devices, perform network address translation, sometimes abbreviated NAT. NAT is required for Internet Protocol version 4 (IPv4) because the address space is insufficient to uniquely address each device coupled to the Internet. Therefore, the Dynamic Host Configuration Protocol (DHCP) was developed to allow reuse of IP addresses. DHCP allows an Internet Service Provider (ISP) to use a pool of public, universal, addresses for communicating with customer IGDs. The IGD then assigns private, local, addresses to each device downstream of the IGD.

FIG. 1 is a prior art view illustrating a common configuration of a hierarchical network with multiple gateway devices. A gateway device 104 may access the Internet via an ISP 102 over a connection 106. The gateway device 104 may identify itself to the ISP and the ISP may assign an IP address to the gateway device 104, in this example, 190.187.110.210. The gateway device 104 is coupled to downstream networks 108 and 109. When a device, such as computer 110, on the downstream network 108 registers with the gateway device 104, the gateway device 104 may assign a private address, in this example, 192.168.100.3. When computer 110 interacts with the ISP/Internet 102, the gateway device 104 accepts data from the computer 110 using the private address and translates it to the public address assigned by the ISP. When responses are received from the ISP/Internet 102, the addresses are re-translated to the private address of the computer 110. This allows the relatively small address space of the 4 octet addressing scheme to be expanded to a much greater number of endpoints.

By convention, the default behavior of gateway devices is to assume an ISP connection upstream and to assign downstream addresses in the range of 192.168.x.x. Valid ranges for each of the second two octets of downstream addresses is 0-255, allowing approximately 65,000 downstream devices to be addressed. These conventions work well enough in a single layer network, when no additional sub-networks are present.

In the two tier network of FIG. 1, a second gateway device 112 assumes its upstream connection is an ISP and requests an address. The gateway device 104 assumes the second gateway device 112 is an endpoint, and, as with computer 110, assigns the second gateway device 112 an address from the private address range, for example, 192.168.100.4. When devices downstream of second gateway device 112, such as printer 116 on network 113 and computer 118 on network 114 request addresses, the second gateway device 112 responds. For example, printer 116 may be assigned address 192.168.100.3 from the default range and similarly, computer 118 may be assigned address 192.168.100.4.

However, several ‘oddities’ can occur in this situation. Two devices, computer 110 and printer 116, now have the same IP address. Additionally, the upstream port of the second gateway device 112 and one of its downstream devices, computer 118 have the same address, 192.168.100.4. Traffic between the computer 110 and printer 116 may be mishandled by the second gateway device 112. As well, traffic destined for the computer 118 may be trapped or misdirected by the second gateway device 112 because it has duplicate addresses on the upstream and downstream sides.

### SUMMARY

A gateway device may be configured to determine when it is downstream of another gateway device and disable its own DHCP server and network address translation capability to simply bridge packets between upstream and downstream networks. The gateway device may make the determination when it sees an assigned address in the 192.168.x.x range. Alternatively, the determination may be made when the gateway device receives a signal indicating that it should not perform network address translation. The signal may come from the upstream, gateway device or may come from a system manager. By disabling network address translation and DHCP, all addressing is handled by the upstream gateway, avoiding duplicate addressing between tiers of the hierarchy.

### BRIEF DESCRIPTION OF THE DRAWINGS

FIG. 1 is a block diagram of a prior art hierarchical network with multiple gateway devices;

FIG. 2 is a block diagram of hierarchical network with multiple gateway devices in accordance with the current disclosure;

FIG. 2A is a block diagram of an alternate embodiment of the hierarchical network of FIG. 2;

FIG. 3 is a block diagram of logical view of a representative gateway device; and

FIG. 4 is a structural view of a representative gateway device.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

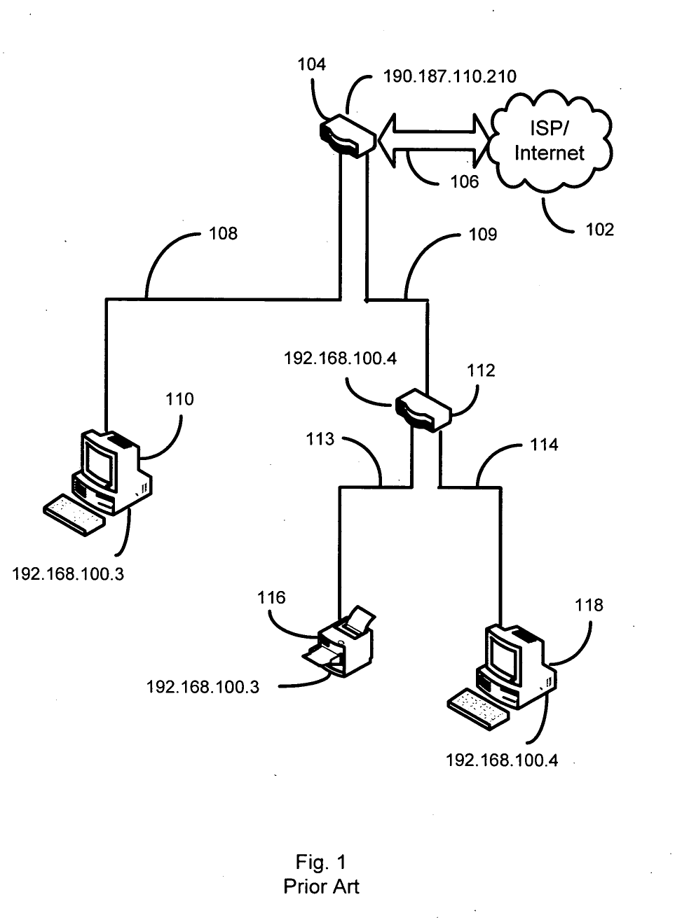

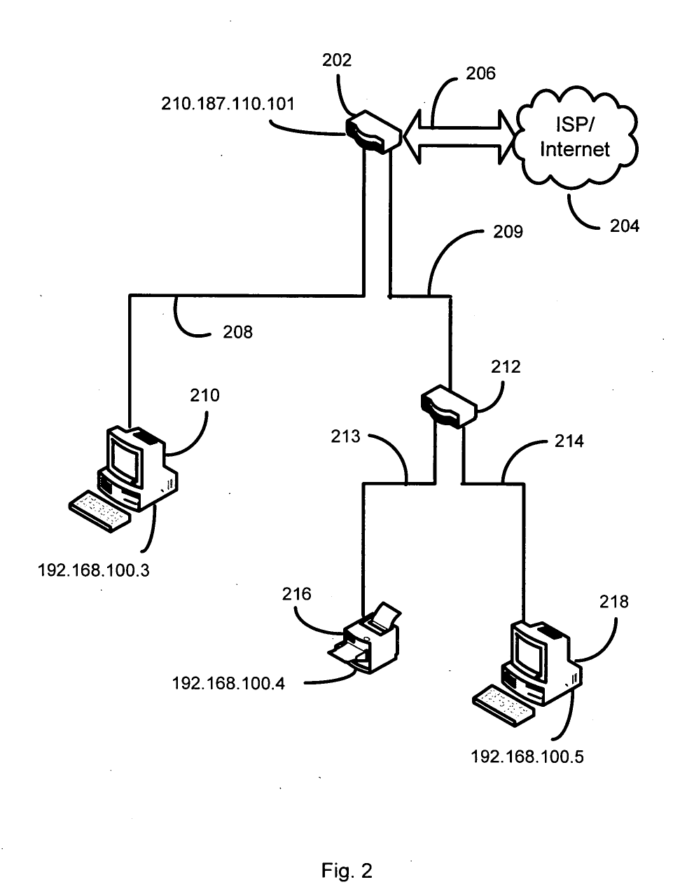

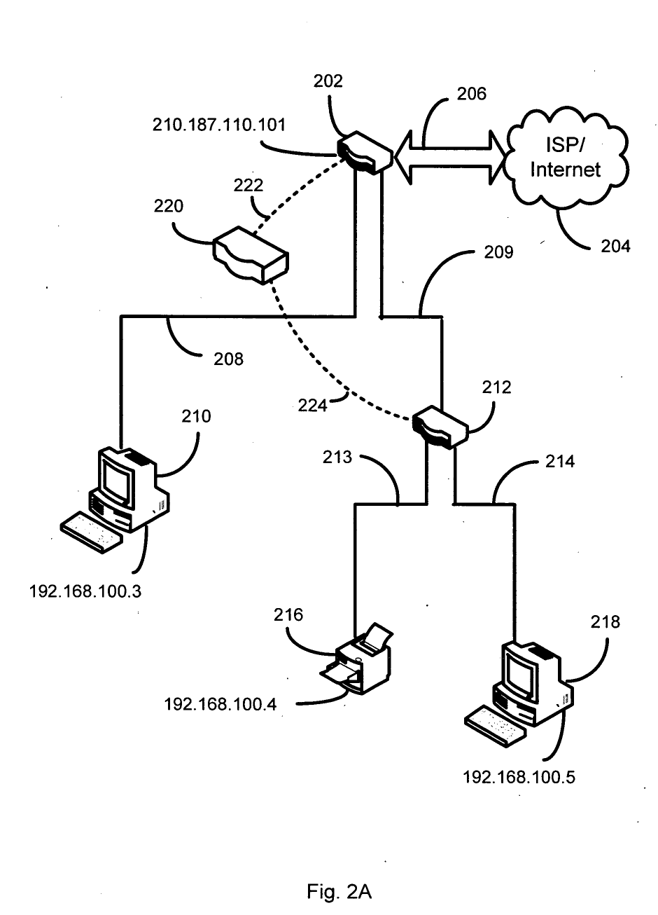

FIG. 2 is a block diagram of hierarchical network with multiple gateway devices. A gateway device 202 may access a wide area network, such as the Internet, via an Internet Service Provider (ISP) 204 over a network connection 206. The network connection and the ISP 204 may be referred to as being on the upstream side of the gateway device 202. As with the prior art embodiment discussed with respect to FIG. 1, the downstream side of the gateway device 202 may be connected to local area networks 208 and 209. Downstream devices, such as a computer 210 and a second gateway device 212, may be connected to the respective local area networks 208 209. The upstream side of the second gateway device 212 may be connected to local area network 209 and the downstream side connected to a local area networks 213 214. Devices downstream from the second gateway device 212 may be printer 216 and computer 218. The scope of the local area networks, such as local area networks 208 and 209, may be expanded with more devices horizontally and additional gateway devices creating more layers vertically with further gateway devices below local area networks 213 or 214. The relatively small scale of the embodiment of FIG. 2 is illustrative only.

As above, gateway device 202 may request, or be assigned, an IP address by the ISP 204. The network address may be an IP address, in this case, 210.187.110.101. Computer 210, using the DHCP protocol to dynamically assign an address or using static IP addressing may be assigned an IP address of 192.168.100.3. However, in one embodiment, when the second gateway device 212 requests an address and receives an IP address in the range of 192.168.x.x, the second gateway device 212 may determine that it is not connected to an ISP, but rather to an upstream gateway device, such as gateway device 202. The second gateway device 212 may then disable its own DHCP server and network address translation functionality and instead provide layer 2 bridging between all interfaces, which may include passing through IP address requests, e.g. DHCP registration requests) from downstream devices and pass traffic bi-directionally without network address translation.

For example, when printer 216 and computer 218 request IP addresses, the request will not be serviced by the second gateway device 212 but the requests will instead be passed to gateway device 202. Gateway device 202 will assign IP addresses using its current methodology, in this case, sequentially. Printer 216 and computer 218 may be assigned IP addresses 192.168.100.4 and 192.168.100.5 respectively. Because only one gateway device 202 is assigning addresses, duplicate addressing is avoided, as are routing problems associated with the second gateway device 212 having the same address on both upstream and downstream sides.

FIG. 2A is an alternate embodiment of the system discussed with respect to FIG. 2, as shown by dotted lines 222 and 224, showing a manager 220 that is logically coupled to each of the gateway devices 202 and 212. The manager may instruct each gateway device as to its role and whether to perform DHCP and network address translation. In this exemplary embodiment, the manager 220 may instruct the gateway device 202 to perform DHCP and network address translation and the gateway device 212 to disable its DHCP and network address translation functions. The manager 220 may be a dedicated device or may be part of a larger network management function that may also perform load balancing or network maintenance and diagnostics, as is known in the art.

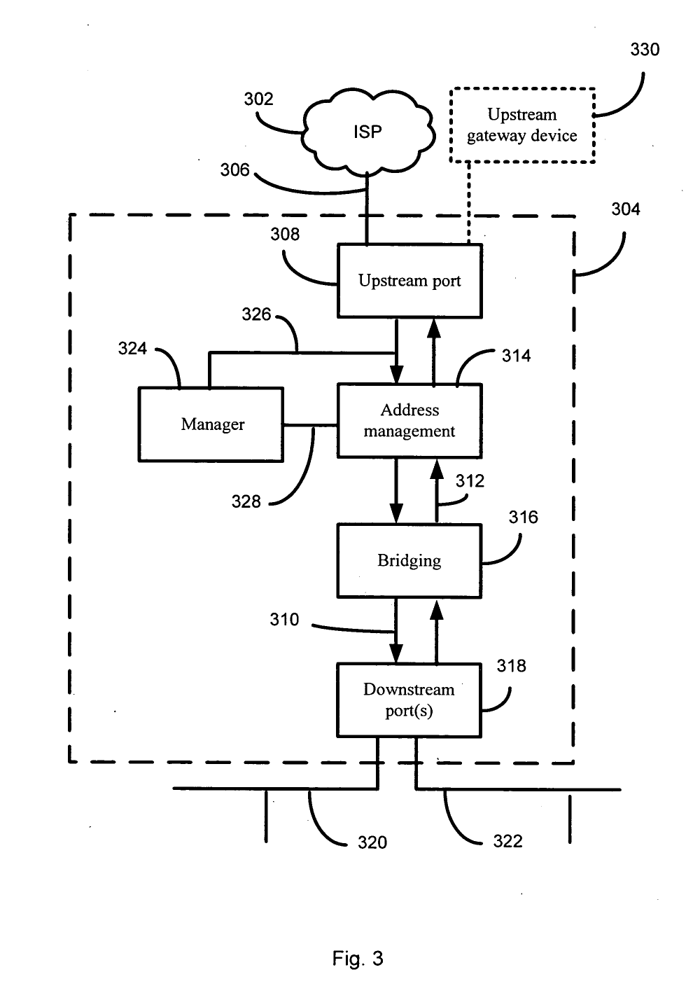

FIG. 3 represents one embodiment of a gateway device 304, the same as or similar to gateway device 202 or 212 of FIG. 2. An ISP 302 may be coupled to the gateway device 304 via connection 306. The gateway device 304 may include an upstream port 308 for supporting bi-directional traffic with the ISP 302. The upstream port 308 may be coupled to other circuits via exemplary data paths 310 and 312. In other configurations, a single bus may be used.

A network address translation circuit 314 or function may assign addresses to downstream devices and perform address translation that is required when a single upstream connection 306 supports one or more downstream connections 320 322, each having different IP addresses from that at the upstream port. The bridging circuit 316 may perform routing between the single upstream connection 306 (via the address translation circuit 314, when active, and the one or more downstream connections 320 322 supported by a corresponding number of downstream ports represented by block 318. A manager 324 may monitor traffic on the upstream port 308 via connection 326. The manager 324 may determine when the traffic on the upstream connection 306 is from an ISP 302, or, as shown in dotted lines, when the upstream port 308 is coupled to another gateway device 330. This determination may be made, as discussed above, by watching the address assigned to the gateway device 304. When the address is in the range 192.168.x x, the manager 324 may assume that the gateway device 304 may be in an alternate configuration downstream of another gateway device 330. In this case, the manager 324 may disable the address management circuit 314 via connection 328 so that the DHCP assignment of addresses (if active) and network address translation are disabled and the gateway device 304 only performs bridging. Such operation is typical of an IPv4 gateway device.

Alternately, the manager 324 may receive a signal from an upstream gateway device, such as gateway device 330, that network address translation is being performed elsewhere and that gateway device 304 should not perform network address translation.

In an alternate network configuration, a system manager, such as system manager 220 of FIG. 2A, may send a signal to the manager 324 with instructions to either enable or disable network address translation, based on the surrounding network architecture and system needs.

When the manager 324 determines that the upstream port 308 is connected to an ISP 302 or other Internet connection, not only may the address management circuit 314 be enabled, but the manager 324 may cause a signal or other message to be broadcast from the downstream port 318 indicating that network address translation is being performed by gateway device 304 and that any downstream gateway devices (not depicted) should not perform network address translation. In Internet Protocol version 6 (IPv4, IPv6) gateway device embodiments, the conditions may be slightly different, but the function is-similar. IPv6 supports longer addresses that are expected to allow every device wishing a public address to have one available. The address management circuit 314 may include using Dynamic Host Configuration Protocol version 6 (DHCPv6) Prefix Delegation for acquiring one or more prefixes for the downstream ports. When the manager 324 determines that the gateway device 304 is behind a security boundary (such as 304) and should only perform a bridging function, it may likewise disable routing and DHCPv6 Prefix Delegation and only perform a bridging function for IPv6 traffic. It is typical for gateways performing a bridging function to do so independent of the type of traffic (whether IPv4 or IPv6 or otherwise).

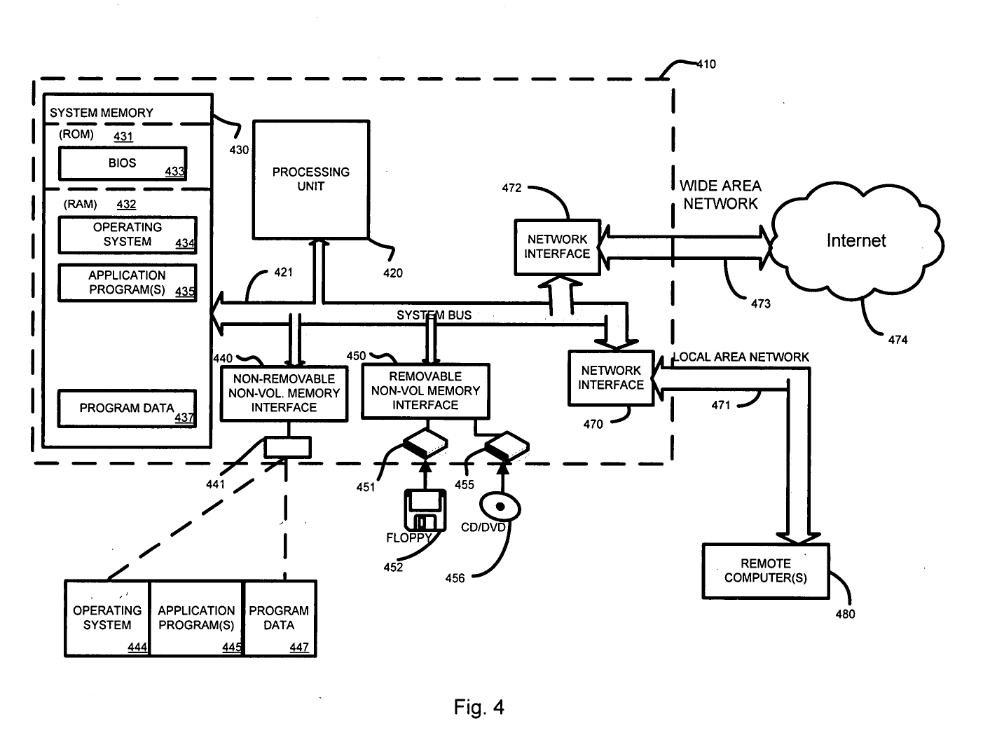

FIG. 4 is a structural view of a representative gateway device 410, the same or similar to gateway device 304 of FIG. 3. The gateway device 410 may have a memory and processing structure similar to a general purpose or special purpose computer. Components of the gateway device 410 may include, but are not limited to a processing unit 420, a system memory 430, and a system bus 421 that couples various system components including the system memory 430 to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 430 may include computer storage media in the form of volatile and/or nonvolatile memory such as read only memory (ROM) 431 and random access memory (RAM) 432. A basic input/output system 433 (BIOS), containing the basic routines that help to transfer information between elements within gateway device 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, and program data 437.

The drives and their associated computer storage media discussed above and drives illustrated in FIG. 4, provide storage of computer readable instructions, data structures, program modules and other data for the gateway device 410. In FIG. 4, for example, hard disk drive 441 is illustrated as storing operating system 444, application programs 445, and program data 447. Note that these components can either be the same as or different from operating system 434, application programs 435, and program data 437. Operating system 444, application programs 445, other program modules 446, and program data 447 are given different numbers here to illustrate that, at a minimum, they are different copies.

The gateway device 410 may also include other removable/non-removable, volatile/nonvolatile computer storage media. By way of example, the gateway device 410 may include a removable non-volatile memory interface 450 that may read from or write to a removable, nonvolatile magnetic disk drive 451 with removable magnetic media 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive interface 440 and the removable non-volatile memory interface 450 are typically connected to the system bus 421. Note that some gateway devices may not have rotating media drives or removable media.

The gateway device 410 may typically include a variety of computer readable media. Computer readable media can be any available media that can be accessed by gateway device 410 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by gateway device 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The gateway device 410 typically operates in a networked environment using logical connections to an upstream device, such as the Internet 474 over wide area network connection 473 via network interface 472. The network interface 472 may be connected to system bus 421. Another network interface 470 may couple one or more downstream computers 480 or other devices (not depicted) through local area network connection 471 that may also be connected to the system bus.

The remote computer 480 may be a personal computer, a server, a router, a network PC, a peer device or other common network node. The logical connections depicted in FIG. 4 include a local area network (LAN) 471 and a wide area network (WAN) 473, but may also include other networks. Such networking environments are commonplace in offices, enterprise-wide computer networks, intranets and the Internet.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. In a gateway device capable of performing at least one of network address translation and layer 3 routing, a method of configuring the gateway device according to a network topology comprising:
detecting that the gateway device is downstream of an upstream gateway device;
determining that the upstream gateway device is performing a security boundary function; and
setting an operating mode of the gateway device to a bridging mode wherein the at least one of network address translation and layer 3 routing is disabled.

2. The method of claim 1 wherein the security boundary function is at least one of a network address translation function and a firewall function.

3. The method of claim 1, wherein determining that the upstream gateway device is performing network address translation comprises determining that the upstream gateway device has assigned an Internet Protocol (IP) address in a predetermined range.

4. The method of claim 3, wherein the predetermined range of the IP address is 192.168.x.x, where x is any valid octet.

5. The method of claim 1, wherein determining that the upstream gateway device is performing network address translation comprises receiving a signal that the upstream gateway device is performing network address translation.

6. The method of claim 5, wherein receiving the signal comprises receiving the signal from the upstream gateway device that the upstream device is performing network address translation.

7. A gateway device comprising:
an upstream port interfacing with a first network supporting Internet protocol addresses in a first range;
a downstream port interfacing with a second network supporting addresses in a second range;
a bridging function that passes traffic between the upstream and downstream ports; and
an address manager coupled to the bridging function that translates addresses for traffic with the downstream device from the address in the first range to the address in the second range;
a sensor that disables the address manager when the sensor determines that as a result of services performed by an upstream device, address translation is not required.

8. The gateway device of claim 7, wherein the address manager assigns a downstream device an address in the second range responsive to a request for an address from the downstream device.

9. The gateway device of claim 7, wherein the sensor comprises an analyzer that determines that the address in the first range on the first network is already a private address wherein the sensor disables the address manager.

10. The gateway device of claim 7, wherein the sensor receives a signal from an upstream device, the signal comprising information that address management is already being performed wherein the sensor disables the address manager.

11. The gateway device of claim 7, wherein the sensor receives a signal from an external manager, the signal comprising information that address management is already being performed wherein the sensor disables the address manager.

12. The gateway device of claim 7, wherein the address manager performs network address translation between a public address in a first range and a private address in the range 192.168.x.x.

13. The gateway device of claim 7, wherein the gateway device is an Internet Protocol version 4 gateway device and the sensor determines that the Internet Protocol address in the first range is an IPv4 private address, wherein the sensor disables the address manager.

14. The gateway device of claim 7, wherein the gateway device is an Internet Protocol version 6 gateway device and the address manager disables routing and DHCPv6 Prefix Delegation functions responsive to a disable signal from the sensor.

15. A system for managing network address translation functions -in an Internet Protocol data network, the system comprising:
a first gateway and at least one other gateway arranged in a hierarchical fashion, with an upstream port of the first gateway coupled to a wide area network and a downstream port of the first gateway coupled to the at least one other gateway; and
a manager that programmatically determines when the first gateway is providing network address translation and disables network address translation and dynamic host configuration protocol (DHCP) at the at least one other gateway.

16. The system of claim 15, wherein the first gateway includes the manager and the manager sends a network address translation disable signal to the at least one other gateway.

17. The system of claim 15, wherein the at least one other gateway includes the manager and the manager determines the first gateway is providing network translation by determining traffic arriving from the first gateway is in a predetermined range of IP addresses.

18. The system of claim 17, wherein the manager determines the first gateway is providing network address translation when the predetermined range of IP addresses of traffic arriving from the first gateway device is 192.168.x.x, where x.x are valid octets.

19. The system of claim 15, wherein the manager is part of the at least one other device and determines the first gateway is providing network translation when a signal from the first gateway device is received that indicates network address translation is being performed.

20. The system of claim 15, wherein the manager is part of a network manager that signals the first gateway device to perform network address translation and signals the at least one other gateway device to disable network address translation and DHCP.
